(19) United States
(12) Patent Application Publication
(10) Pub. No.: US 2020/0180574 A1
(43) Pub. Date: Jun. 11, 2020

(54) HEIGHT CLEARANCE DETECTION FOR A VEHICLE-ATTACHMENT SYSTEM

(71) Applicant: Continental Automotive Systems, Inc., Auburn Hills, MI (US)

(72) Inventors: Dean Allen Beckman, Highland, MI (US); James Hockridge Critchley, Lake Orion, MI (US)

(73) Assignee: Continental Automotive Systems, Inc., Auburn Hills, MI (US)

(21) Appl. No.: 16/214,218

(22) Filed: Dec. 10, 2018

(51) Int. Cl. B60T 7/20; B60T 7/12; B60Q 9/00; G01B 11/14

(52) U.S. Cl. CPC B60T 7/20; B60T 7/12; B60T 2210/30; G01B 11/14; B60Q 9/008

(57) ABSTRACT

A method for detecting an obstruction vertical clearance associated with an obstruction positioned in front of a vehicle-attachment system is provided. The vehicle-attachment system includes a vehicle and an attachment. The method includes receiving forward sensor data from a forward sensor system having a forward field-of-view. The method includes determining the obstruction vertical clearance of the obstruction based on the forward sensor data. The method also includes receiving rearward sensor data from a rearward-facing sensor system having a rearward field-of-view. Additionally, the method includes determining a vehicle-attachment system height based on the rearward sensor data. The method includes comparing the obstruction vertical clearance and the vehicle-attachment system height. The method also includes transmitting to a user interface, instructions to notify a driver of the vehicle the result of the comparison between the obstruction vertical clearance and the vehicle-attachment system height.

### TECHNICAL FIELD

The disclosure relates to a method and device for determining a vertical clearance of an obstruction and determining if a vehicle-attachment system can pass under the obstruction. The vehicle-attachment system includes a tow vehicle and an attachment, e.g., a trailer, a hitch rack, or an object positioned on a rooftop or a truck bed of the tow vehicle.

### BACKGROUND

A tow vehicle, such as, but not limited to a car, a crossover, a truck, a van, a sports-utility-vehicle (SUV), a recreational vehicle (RV), and a semi-truck may be configured to tow a trailer or to support one or more objects on its rooftop, in a truck-bed or as a hitch attachment. The trailer may be a utility trailer, a popup camper, a travel trailer, livestock trailer, flatbed trailer, enclosed car hauler, semi-trailer, or a boat trailer, among others. The tow vehicle may support a rooftop storage rack that keeps objects, such as bikes and luggage up and out of the way while driving the tow vehicle. In other examples, the tow vehicle is attached to a hitch storage rack that keeps the objects behind the vehicle. In some example, the tow vehicle is a truck having a truck bed that supports objects.

The tow vehicle may attach to the trailer using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used. In addition to the mechanical connection between the trailer and the powered vehicle, in some examples, the trailer is electrically connected to the tow vehicle. As such, the electrical connection allows the trailer to take the feed from the powered vehicle's rear light circuit, allowing the trailer to have taillights, turn signals, and brake lights that are in sync with the lights of the powered vehicle.

In some examples, a height of the vehicle-attachment system may vary based on the type of the attachment, which makes it difficult for a driver to drive the vehicle-attachment system under overpasses or parking garages due to the unknown height of the vehicle-attachment system. As such, it is desirable to provide a vehicle-attachment system that improves driver safety while driving a tow vehicle having an attachment, especially when driving in a parking garage or under an overpass.

### SUMMARY

One aspect of the disclosure provides a method for detecting an obstruction vertical clearance associated with an obstruction positioned in front of a vehicle-attachment system. The vehicle-attachment system includes a vehicle and an attachment (e.g., a trailer, a hitch rack, or an object positioned on a vehicle rooftop or truck bed). The method includes receiving, at a processing hardware supported by the vehicle, forward-facing sensor data from a forward sensor system having a forward field-of-view for capturing a forward environment of the vehicle. The method also includes determining, at the processing hardware, the obstruction vertical clearance of the obstruction based on the forward-facing sensor data. The method also includes receiving, at the processing hardware, rearward sensor data from a rearward-facing sensor system having a rearward field-of-view for capturing a rearward environment of the vehicle. The method also includes determining, at the processing hardware, a vehicle-attachment system height based on the rearward sensor data. In addition, the method includes comparing, at the processing hardware, the obstruction vertical clearance and the vehicle-attachment system height. The method includes transmitting, from the processing hardware to a user interface in communication with the processing hardware, instructions to notify a driver of the vehicle a result of the comparison between the obstruction vertical clearance and the vehicle-attachment system height.

Implementations of the disclosure may include one or more of the following optional features. In some implementations, the rearward field-of-view captures data associated with one or more objects supported by a rooftop of the vehicle. The vehicle-attachment system may include the vehicle and a trailer attached to the vehicle. In this case, the rearward field-of-view captures data associated with the trailer.

In some implementations, determining the vehicle-attachment system height based on the rearward sensor data includes: receiving a vehicle height from memory hardware in communication with the processing hardware; determining an attachment height based on the received rearward-facing data; and setting the vehicle-attachment system height as the greater one of the vehicle height and the attachment height.

In some examples, when the obstruction vertical clearance is less than the vehicle-attachment system height, the method includes transmitting, from the processing hardware to a brake system in communication with the processing hardware, instructions to stop the vehicle. When the attachment is a trailer, the method may include transmitting, from the processing hardware, instructions to a trailer brake system to stop the trailer.

In some implementations, comparing the obstruction vertical clearance and vehicle-attachment system height includes: determining an adjusted vertical clearance based on the determined vertical clearance; and comparing the adjusted vertical clearance with the vehicle-attachment system height. The adjusted vertical clearance being less than the determined vertical clearance by a predefined value.

Another aspect of the disclosure provides a tow vehicle attached to or supporting an attachment. The tow vehicle includes: a user interface; a sensor system, a controller, and memory hardware. The sensor system includes a forward-facing sensor system having a forward field-of-view for capturing a forward environment of the tow vehicle, and a rearward-facing sensor system having a rearward field-of-view for capturing a rearward environment of the tow vehicle. The rearward environment includes the attachment attached to or supported by the tow vehicle. The processing hardware is in communication with the user interface and the sensor system, and the memory hardware is in communication with the processing hardware. The memory hardware stores instructions that when executed on the processing hardware cause the processing hardware to perform operations for detecting an obstruction vertical clearance associated with an obstruction positioned in front of the tow vehicle. The operations include: receiving forward-facing sensor data from the forward-facing sensor system. The operations also include determining the obstruction vertical clearance of the obstruction based on the forward-facing sensor data. The operations also include receiving rearward sensor data from the rearward-facing sensor system. The operations also include determining a vehicle-attachment system height based on the rearward sensor data. The vehicle-attachment system height being a height of the tow vehicle and the attachment. The operations also include comparing the obstruction vertical clearance and the vehicle-attachment system height. Additionally, the operations include transmitting to the user interface in communication with the processing hardware, instructions to notify a driver of the tow vehicle a result of the comparison between the obstruction vertical clearance and the vehicle-attachment system height.

Implementations of this aspect of the disclosure may include one or more of the following optional features. In some implementations, the rearward field-of-view captures data associated with one or more objects supported by a rooftop of the tow vehicle. The tow vehicle may be attached to a trailer, and the rearward field-of-view captures data associated with the trailer.

In some examples, determining the vehicle-attachment system height based on the rearward sensor data includes: receiving a vehicle height; and determining an attachment height based on the received rearward-facing data; and setting the vehicle-attachment system height as the greater one of the vehicle height and the attachment height.

In some implementations, when the obstruction vertical clearance is less than the vehicle-attachment system height, the operations further include: transmitting, from the processing hardware to a brake system in communication with the processing hardware, instructions to stop the tow vehicle. When the attachment is a trailer, the operations further include: transmitting, from the processing hardware, instructions to a trailer brake system, instruction to stop the trailer. In some examples, comparing the obstruction vertical clearance and vehicle-attachment system height includes: determining an adjusted vertical clearance based on the determined vertical clearance, and comparing the adjusted vertical clearance with the vehicle-attachment system height. The adjusted vertical clearance being less than the determined vertical clearance by a predefined value.

The details of one or more implementations of the disclosure are set forth in the accompanying drawings and the description below. Other aspects, features, and advantages will be apparent from the description and drawings, and from the claims.

### DETAILED DESCRIPTION

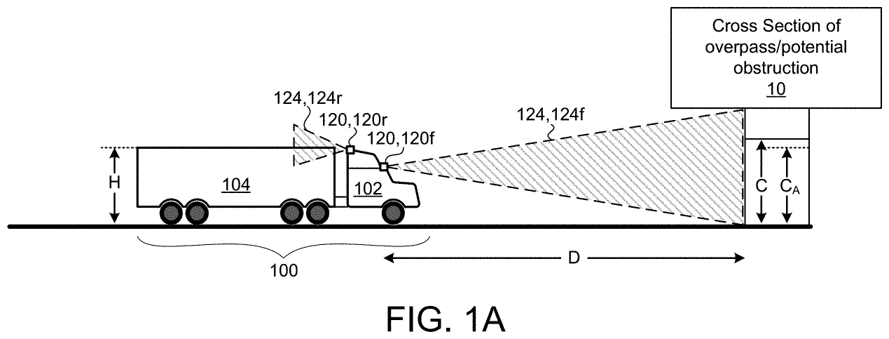

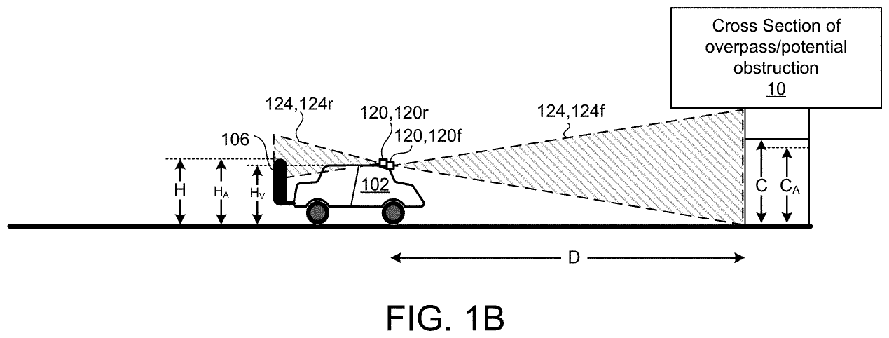

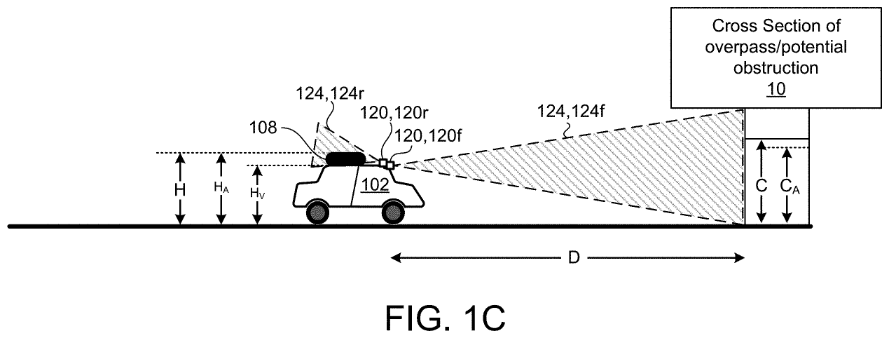

FIG. 1A is a schematic view of an exemplary vehicle-attachment system including a tow vehicle and a trailer.

FIG. 1B is a schematic view of an exemplary vehicle-attachment system including a tow vehicle and a hitch rack.

FIG. 1C is a schematic view of an exemplary vehicle-attachment system including a tow vehicle and a roof top mount.

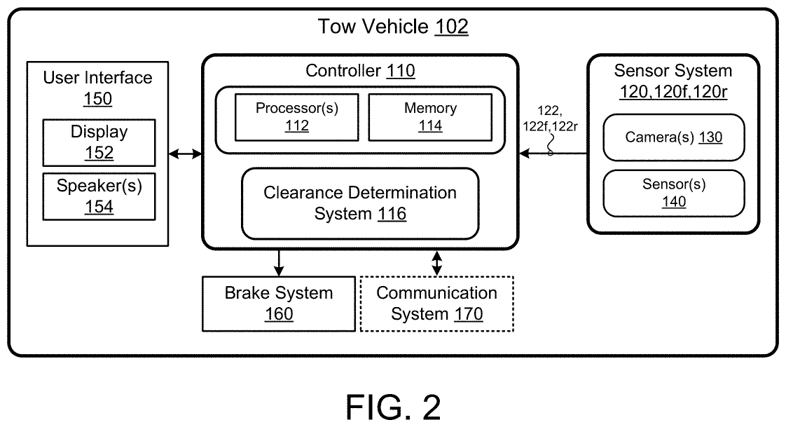

FIG. 2 is a schematic view of the exemplary tow vehicle of FIGS. 1A-1C having a clearance determination system.

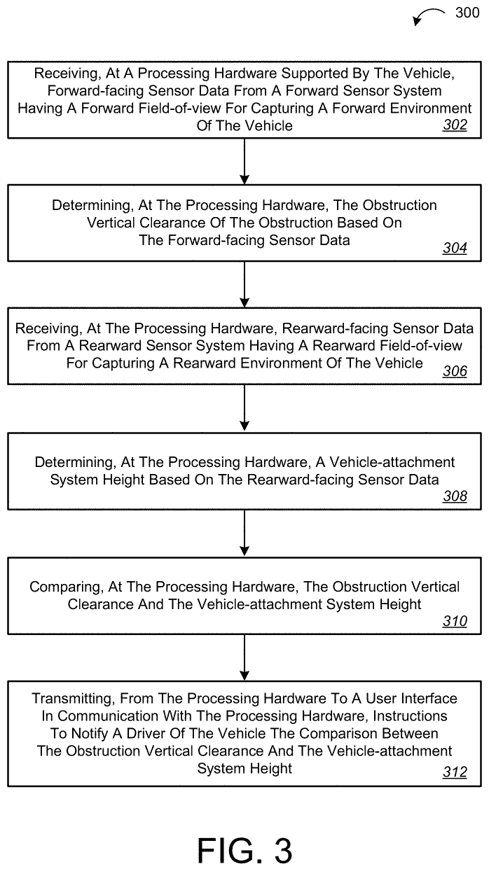

FIG. 3 is schematic view of an exemplary arrangement of operations for determining if the vehicle-attachment system can pass under an obstruction.

Like reference symbols in the various drawings indicate like elements.

### DETAILED DESCRIPTION

A tow vehicle, such as, but not limited to a car, a crossover, a truck, a van, a sports-utility-vehicle (SUV), a recreational vehicle (RV), and a semi-truck may be configured to tow a trailer or to support one or more objects on its rooftop or as a hitch attachment. It is desirable to have a tow vehicle that is configured to determine a vertical clearance associated with a potential obstruction, such as, but not limited to, an overpass, a covered parking garage, a residential garage, power lines, and a fast food drive thru, and alert the driver if the vertical clearance is greater than a height of the vehicle-attachment system.

Referring to FIGS. 1A-2, in some implementations, a vehicle-attachment system 100 includes a tow vehicle 102 and an attachment 104, 106, 108 (e.g., a trailer 104 as shown in FIG. 1A, a hitch rack 106 as shown in FIG. 1B, or an object 108 positioned on a vehicle rooftop as shown in FIG. 1C). The tow vehicle 102 may include a controller 110 that includes a computing device (or hardware processor) 112 (e.g., central processing unit having one or more computing processors) in communication with non-transitory memory or hardware memory 114 (e.g., a hard disk, flash memory, random-access memory) capable of storing instructions executable on the computing processor(s) 112.

The vehicle controller 110 executes a clearance determination system 116 which compares a height H of the vehicle-attachment system 100 with a vertical clearance height C of an obstruction 10 and determines if the height H of the vehicle-attachment system 100 is less than, equal to, or greater than the vertical clearance C of the obstruction 10. In other words, the clearance determination system 116 determines if the vehicle-attachment system 100 is cleared to pass under the obstruction 10 based on the comparison between the height H of the vehicle-attachment system 100 and the vertical clearance C of the obstruction 10.

The tow vehicle 102 includes a sensor system 120 to provide a reliable and robust driving experience to the driver. The sensor system 120 is in communication with the controller 110 and transmits sensor system data 122 to the controller 110. In some examples, the sensor system 120 includes a forward-facing sensor system 120f and a rearward-facing sensor system 120r. As such, the forward-facing sensor system 120f provides forward sensor data 122f associated with a forward field-of-view 124, 124f of the tow vehicle 102, while the rearward-facing sensor system 120r provides rearward-facing sensor system data 122r associated with the rearward field-of-view 124, 124r of the tow vehicle 102. As shown, the forward field-of-view 124f captures forward sensor data 122f that includes data associated with one or more obstructions 10 in front of the tow vehicle 102. In addition, the rearward field-of-view 124r captures rearward sensor data 122r that includes data associated with the attachment 104, 106, 108. For example, the rearward-facing sensor system 120r captures data associated with the trailer 104 as shown in FIG. 1A, data associated with the hitch rack 106 as shown in FIG. 1B, data associated with the object 108 as shown in FIG. 1C. The sensor system 120 may include different types of sensors that may be used separately or with one another to create a perception of the environment of the tow vehicle 102. The sensor system 120, 120f, 120r may include one or more cameras 130 and/or one or more sensors 140. In some examples, the sensor system 120 includes the forward sensor system 120f as a standalone system in communication with the rearward-facing sensor system 120r also being a standalone system, as shown in FIG. 1A. While in other examples, the sensor system 120 is one module supported by the tow vehicle 102 and includes the forward-facing sensor system 120f and the rearward-facing sensor system 120r, as shown in FIGS. 1B and 1C.

The one or more cameras 130 may be a monocular camera, binocular camera, or another type of sensing device capable of providing a view of the front or rear field-of-view 124f, 124r of the tow vehicle 102. In some examples, the one or more sensors 140 include, but are not limited to radar, sonar, LIDAR (Light Detection and Ranging, which can entail optical remote sensing that measures properties of scattered light to find range and/or other information of a distant target), HFL (High Flash LIDAR), LADAR (Laser Detection and Ranging), etc.

The tow vehicle 102 may include a user interface 150 that allows the driver and the controller 110 to exchange information. In some examples, the user interface 150 includes a display 152 and/or speakers 154. In some examples, the display 152 is a touch screen display. In other examples, the display 152 is in communication with one or more input mechanisms allowing the driver to input data or make a selection on the display 152. The input mechanism may be a rotary knob or a mouse.

The tow vehicle 102 may include a brake system 160 in communication with the controller 110. The brake system 160 includes brakes (not shown) associated with each wheel of the tow vehicle 102. In some examples, where the attachment is a trailer 104, the brake system 160 is in communication with a trailer brake system (not shown); therefore, a signal from the controller 110 to the brake system 160 may control both the tow vehicle brake system 160 and the trailer brake system.

As a driver is driving the tow vehicle 102, the forward-facing sensor system 120f captures forward sensor data 122f of the forward field-of-view 124f of the tow vehicle 102, while the rearward-facing sensor system 120r captures rearward sensor data 122r of the rearward field-of-view 124r of the tow vehicle 102. The controller 110 receives the forward sensor data 122f and analyzes the received forward sensor data 122f. Based on the analyzed forward sensor data 122f, the controller 110 determines the vertical clearance C of the obstruction 10. The obstruction 10 positioned at a distance D in front of the vehicle-attachment system 100. As the vehicle-attachment system 100 approaches the obstruction 10, the distance D decreases.

In some implementations, the controller 110 instructs the display 152 to solicit a user input of the attachment height H_{A} by way of one or more messages displayed on the display 152 to which the driver inputs a value. In some examples, when the attachment is a trailer 104, the driver may know the trailer height H_{A}. In this case, the controller 110 sets the height H of the vehicle-attachment system 100 as the greater one of the inputted trailer height H_{A} and the height H_{V} of the tow vehicle 102 (stored in the memory 114). Once the height H of the vehicle-attachment system 100 is determined, the controller compares the height H of the vehicle-attachment system 100 with the vertical clearance C of the obstruction 10. If the controller 110 determines that the vehicle-attachment height H is less than the obstruction vertical clearance C, in other words, the obstruction vertical clearance C is greater than the trailer height H, then the controller 110 determines that the vehicle-attachment system 100 is cleared to drive under the obstruction 10. In some examples, the controller 110 may inform the driver via the user interface, i.e., a message on the display 152 or a sound via the speakers 154, that the vehicle-attachment system 100 is cleared to drive under the obstruction 10. If the controller 110 determines that the vehicle-attachment height H is greater or equal to the obstruction vertical clearance C, in other words, the obstruction vertical clearance C is less than or equal to the trailer height H, then the controller 110 determines that the vehicle-attachment system 100 is not cleared to drive under the obstruction 10. In this case, the controller 110 may alert the driver via the user interface 150 of the pending conflict between the vehicle-attachment height H and the obstruction vertical clearance C. Additionally or alternatively, the controller 110 may instruct the brake system 160 to stop the vehicle 102 to ensure that a collision with the obstruction 10 is avoided. The controller 110 may instruct the brake system 160 to stop the vehicle 102 at a predefined distance D before the vehicle-attachment system 100 reaches the obstruction 10.

In some implementations, the controller 110 determines an adjusted obstruction vertical clearance C_{A} based on the determined vertical clearance C. The vertical clearance C_{A} is the obstruction vertical clearance C minus a predefined clearance value, which gives the vehicle-attachment system 100 extra clearance to accommodate for road bumps or other factors. The adjusted obstruction vertical clearance C_{A} is less than the obstruction vertical clearance C. The controller 110 may use the adjusted obstruction vertical clearance C_{A} instead of the determined obstruction vertical clearance C when determining if the vehicle-attachment system 100 can pass under the obstruction 10.

In some examples, the tow vehicle 102 includes a navigation database stored on the hardware memory 114. The navigation database includes database vertical clearance C_{D} values associated with one or more obstructions 10. In some instances, a database vertical clearance C_{D} associated with an obstruction 10 is displayed on the display 152 as the driver approaches the obstruction 10. In this case, the controller 110 may compare the obstruction vertical clearance C with the database vertical clearance C_{D} and alert the driver of any discrepancies. For example, if the database vertical clearance C_{D} is less than the determined obstruction vertical clearance C, then the controller 110 alerts the driver, via the user interface 150, that the database vertical clearance C_{D} is not correct.

In some implementations, the controller 110 receives rearward sensor data 122r from the rearward-facing sensor system 120r associated with the rearward field-of-view 124r and analyses the data 122r to determine the height of the vehicle-attachment system 100, thus eliminating the need to solicit the vehicle-attachment system height H from the driver. The controller 110 receives the rearward sensor data 122r and analyses the data 122r. Based on the analyzed sensor data 122r, the controller 110 may determine the height of the attachment 104, 106, 108. The controller 110 determines the height H of the vehicle-attachment system 100 by selecting the greater one of the height of the attachment 104, 106, 108 and the height of the tow vehicle 102 which is stored in the non-transitory memory 114 of the controller 110.

In some implementations, the tow vehicle 102 includes a communication system 170 that allows the tow vehicle 102 to communicate with one or more vehicles via the internet or via vehicle-to-vehicle communications (V2V), vehicle-to-infrastructure communicate (V2I), vehicle-to-pedestrian communicate (V2P), or vehicle-to-network communicate (V2N). The tow vehicle 102 may receive information associated with the vertical obstruction clearance C and based on the received information, determine if the vehicle-attachment system 100 is cleared to pass under the obstruction 10.

FIG. 3 is a schematic view of an exemplary arrangement of operations for a method 300 of detecting an obstruction vertical clearance C associated with an obstruction 10 positioned in front of the vehicle-attachment system 100 as described in FIGS. 1A-2. The vehicle-attachment system 100 includes a vehicle 102 and an attachment 104, 106, 108 (e.g., a trailer 104 as shown in FIG. 1A, a hitch rack 106 as shown in FIG. 1B, or an object 108 positioned on a vehicle rooftop as shown in FIG. 1C). At block 302, the method 300 includes receiving, at a processing hardware 112 supported by the vehicle 102, forward sensor data 122f from a forward-facing sensor system 120f having a forward field-of-view 124f for capturing a forward environment of the vehicle 102. At block 304, the method 300 includes determining, at the processing hardware 112, the obstruction vertical clearance C of the obstruction 10 based on the forward sensor data 122f. At block 306, the method 300 includes receiving, at the processing hardware 112, rearward sensor data 122r from a rearward-facing sensor system 120r having a rearward field-of-view 124r for capturing a rearward environment of the vehicle 102. At block 308, the method 300 includes determining, at the processing hardware 112, a vehicle-attachment system height H based on the rearward sensor data 122r. At block 310, the method 300 includes comparing, at the processing hardware 112, the obstruction vertical clearance C and the vehicle-attachment system height H. At block 312, the method 300 includes transmitting, from the processing hardware 112 to a user interface 150 in communication with the processing hardware 112, instructions to notify a driver of the vehicle 102 a result of the comparison between the obstruction vertical clearance C and the vehicle-attachment system height H.

In some implementations, the rearward field-of-view 124r captures data 122r associated with one or more objects supported by a rooftop of the vehicle 102. In other implementations, the vehicle-attachment system includes the vehicle 102 and a trailer 104 attached to the vehicle 102, and the rearward field-of-view 124r captures data associated with the trailer 104.

In some examples, determining the vehicle-attachment system height H based on the rearward sensor data 122r includes: receiving, from memory hardware 114 in communication with the processing hardware 112, a vehicle height H_{V}; determining an attachment height H_{A} based on the received rearward-facing data 122r; and setting the vehicle-attachment system height H as the greater one of the vehicle height H_{V} and the attachment height H_{A}.

In some example, when the obstruction vertical clearance C is less than the vehicle-attachment system height H, the method 300 includes transmitting, from the processing hardware 112 to a brake system 160 in communication with the processing hardware 112, instructions to stop the vehicle 102, when the attachment 104, 106, 108 is a trailer 104, the method 300 includes transmitting, from the processing hardware 112, instructions to a trailer brake system, instruction to stop the trailer 104.

In some implementations, comparing the obstruction vertical clearance C and vehicle-attachment system height H includes: determining an adjusted vertical clearance C_{A} based on the determined vertical clearance C, the adjusted vertical clearance C_{A} being less than the determined vertical clearance C by a predefined value; and comparing the adjusted vertical clearance C_{A} with the vehicle-attachment system height H.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for detecting an obstruction vertical clearance associated with an obstruction positioned in front of a vehicle-attachment system, the vehicle-attachment system comprising a vehicle and an attachment, the method comprising:
receiving, at a processing hardware supported by the vehicle, forward sensor data from a forward sensor system having a forward field-of-view for capturing a forward environment of the vehicle;
determining, at the processing hardware, the obstruction vertical clearance of the obstruction based on the forward sensor data;
receiving, at the processing hardware, rearward sensor data from a rearward-facing sensor system having a rearward field-of-view for capturing a rearward environment of the vehicle;
determining, at the processing hardware, a vehicle-attachment system height based on the rearward sensor data;
comparing, at the processing hardware, the obstruction vertical clearance and the vehicle-attachment system height; and
transmitting, from the processing hardware to a user interface in communication with the processing hardware, instructions to notify a driver of the vehicle a result of the comparison between the obstruction vertical clearance and the vehicle-attachment system height.

2. The method of claim 1, wherein the rearward field-of-view captures data associated with one or more objects supported by a rooftop of the vehicle.

3. The method of claim 1, wherein the vehicle-attachment system comprises the vehicle and a trailer attached to the vehicle, and wherein the rearward field-of-view captures data associated with the trailer.

4. The method of claim 1, wherein determining the vehicle-attachment system height based on the rearward sensor data comprises:
receiving, from memory hardware in communication with the processing hardware, a vehicle height;
determining an attachment height based on the received rearward-facing data; and
setting the vehicle-attachment system height as the greater one of the vehicle height and the attachment height.

5. The method of claim 1, further comprising when the obstruction vertical clearance is less than the vehicle-attachment system height, transmitting, from the processing hardware to a brake system in communication with the processing hardware, instructions to stop the vehicle.

6. The method of claim 5, further comprising, when the attachment is a trailer, transmitting, from the processing hardware, instructions to a trailer brake system to stop the trailer.

7. The method of claim 1, wherein comparing the obstruction vertical clearance and vehicle-attachment system height comprises:
determining an adjusted vertical clearance based on the determined vertical clearance, the adjusted vertical clearance being less than the determined vertical clearance by a predefined value; and
comparing the adjusted vertical clearance with the vehicle-attachment system height.

8. A tow vehicle attached to or supporting an attachment, the tow vehicle comprising:
a user interface;
a sensor system comprising:
a forward-facing sensor system having a forward field-of-view for capturing a forward environment of the tow vehicle; and
a rearward-facing sensor system having a rearward field-of-view for capturing a rearward environment of the tow vehicle, the rearward environment including the attachment attached to or supported by the tow vehicle;
a controller comprising:
processing hardware in communication with the user interface and the sensor system; and
memory hardware in communication with the processing hardware, the memory hardware storing instructions that when executed on the processing hardware cause the processing hardware to perform operations for detecting an obstruction vertical clearance associated with an obstruction positioned in front of the tow vehicle, the operations comprising:
receiving forward sensor data from the forward-facing sensor system;
determining the obstruction vertical clearance of the obstruction based on the forward sensor data;
receiving rearward sensor data from the rearward-facing sensor system;
determining a vehicle-attachment system height based on the rearward sensor data, the vehicle-attachment system height being a height of the tow vehicle and the attachment;
comparing the obstruction vertical clearance and the vehicle-attachment system height; and
transmitting to the user interface in communication with the processing hardware, instructions to notify a driver of the tow vehicle a result of the comparison between the obstruction vertical clearance and the vehicle-attachment system height.

9. The tow vehicle of claim 8, wherein the rearward field-of-view captures data associated with one or more objects supported by a rooftop of the tow vehicle.

10. The tow vehicle of claim 8, wherein the tow vehicle is attached to a trailer, and wherein the rearward field-of-view captures data associated with the trailer.

11. The tow vehicle of claim 8, wherein determining the vehicle-attachment system height based on the rearward sensor data comprises:
receiving a vehicle height;
determining an attachment height based on the received rearward-facing data; and
setting the vehicle-attachment system height as the greater one of the vehicle height and the attachment height.

12. The tow vehicle of claim 8, wherein the operations further comprise: when the obstruction vertical clearance is less than the vehicle-attachment system height, transmitting, from the processing hardware to a brake system in communication with the processing hardware, instructions to stop the tow vehicle.

13. The tow vehicle of claim 12, wherein the operations further comprise: when the attachment is a trailer, transmitting, from the processing hardware, instructions to a trailer brake system, instruction to stop the trailer.

14. The tow vehicle of claim 8, wherein comparing the obstruction vertical clearance and vehicle-attachment system height comprises:
determining an adjusted vertical clearance based on the determined vertical clearance, the adjusted vertical clearance being less than the determined vertical clearance by a predefined value; and
comparing the adjusted vertical clearance with the vehicle-attachment system height.
